(19) United States
(12) Patent Application Publication
(10) Pub. No.: US 2022/0239959 A1
(43) Pub. Date: Jul. 28, 2022

(54) METHOD AND SYSTEM FOR VIDEO SCALING RESOURCES ALLOCATION

(71) Applicant: VASTAI Holding Company, Grand Cayman (KY)

(72) Inventors: Lei Zhang, Ontario (CA); Xihe Gao, Ontario (CA); Uhijun Yao, Ontario (CA)

(21) Appl. No.: 17/596,470

(22) PCT Filed: Jun. 10, 2020
(86) PCT No.: PCT/CA2020/050791

§ 371 Date: Dec. 10, 2021

Related U.S. Application Data
(60) Provisional application No. 62/859,987, filed on Jun. 11, 2019.

(51) Int. Cl. H04N 21/2343; H04N 21/44; H04N 19/85

(52) U.S. Cl. CPC H04N 21/234363; G06N 20/00; H04N 19/85; H04N 21/44

(57) ABSTRACT

A method and system for allocating video scaling resources in a deep learning model across a communication network. The method comprises estimating a first set of layers of the deep learning model for downscaling of a video content stream generated at a video server of the communication network; estimating a second set of layers of the deep learning model for upscaling of the video content stream at a rendering device of the communication network; and allocating resources amongst the video server and the rendering device at least partly in accordance with the first set and the second set, wherein the allocating minimizes resources allocated for upscaling at the rendering device and optimizes the video quality of the video displayed at the rendering device.

### TECHNICAL FIELD

The disclosure herein relates to the field of deep learning networks for resources allocation in video processing.

### BACKGROUND

Machine learning systems provide critical tools to advance new technologies including image processing and computer vision, automatic speech recognition and autonomous vehicles. Video consists of 70% of Internet traffic in the U.S. New video encoding standards have been developed to reduce the bandwidth requirement. The new encoding standards such as H265 (or High Efficiency Video Coding) encoding or Alliance of Open Media's AV1 encoding reduces the bandwidth requirement over the previous generations.

However, the increase of the resolution and refresh rate of video increases the bandwidth requirement to transfer the encoded video streams over the Internet. In addition, the last mile of the Internet can be a mobile network, and even in 5G network the bandwidth can be fluctuating and cannot be guaranteed. Furthermore, there currently exists no guaranteed Quality of Service (QoS) in the Internet, which adds to the video delivery problem.

### BRIEF DESCRIPTION OF THE DRAWINGS

FIG. 1 illustrates, in an example embodiment, an architecture 100 of a platform video scaling system within a communication network.

FIG. 2 illustrates, in an example embodiment, a system architecture incorporating a deep learning-based upscaling at a rendering device side.

FIG. 3 illustrates, in an example embodiment, an architecture 300 of a deep learning based downscaling system.

FIG. 4 illustrates, in another example embodiment, an architecture 400 of a deep learning based platform video scaling and processing system.

FIG. 5 illustrates, in one example embodiment, an architecture 500 of a deep learning based neural network video scaling and processing system.

FIG. 6 illustrates, another example embodiment, an architecture 600 of a deep learning based neural network video scaling and processing system.

FIG. 7 illustrates, in an example embodiment, a method of allocating video scaling resources amongst devices coupled in a communication network.

### DETAILED DESCRIPTION

Among other technical advantages and benefits, solutions herein provide for allocating of video scaling computational processing resources in an artificial intelligence deep learning model in a manner that optimizes generation, transmission, and rendering of the video content amongst a video generating server device and one or more video rendering devices within a communication network system. In particular, the disclosure herein introduces a new method of device artificial intelligence (AI)-resource aware jointly optimized networks for both deep-learning-based downscaling at the video generating server in conjunction with upscaling at the video rendering device side. AI and deep learning are used interchangeably as referred to herein.

In accordance with a first example embodiment, a method of allocating video scaling resources across devices of a communication network is provided. The method includes estimating a first set of layers of the deep learning model for downscaling of a video content stream generated at a video server of the communication network; estimating a second set of layers of the deep learning model for upscaling of the video content stream at a rendering device of the communication network; and allocating resources amongst the video server and the rendering device at least partly in accordance with the first set and the second set, wherein the allocating minimizes resources allocated for upscaling at the rendering device and optimizes the video quality of the video displayed at the rendering device.

In accordance with a second example embodiment, a non-transient memory including instructions executable in one or more processors is provided. The instructions are executable to estimate a first set of layers of the deep learning model for downscaling of a video content stream generated at a video server of the communication network; estimate a second set of layers of the deep learning model for upscaling of the video content stream at a rendering device of the communication network; and allocate resources amongst the video server and the rendering device at least partly in accordance with the first set and the second set, wherein the allocating minimizes resources allocated for upscaling at the rendering device and optimizes the video quality of the video displayed at the rendering device.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device.

Furthermore, one or more embodiments described herein may be implemented through the use of logic instructions that are executable by one or more processors. These instructions may be carried on a computer-readable medium. In particular, machines shown with embodiments herein include processor(s), various forms of memory for storing data and instructions, including interface and associated circuitry. Examples of computer-readable mediums and computer storage mediums include flash memory and portable memory storage units. A processor device as described herein utilizes memory, and logic instructions stored on computer-readable medium. Embodiments described herein may be implemented in the form of computer processor-executable logic instructions in conjunction with programs stored on computer memory mediums, and in varying combinations of hardware in conjunction with the processor-executable instructions or code.

### System Description

Video resolutions are typically specified in 8K, 4K, 1080p, 720p, 540p, 360p, etc. Higher resolution requires more bandwidth, given the same refresh rate and same encoding standard. For example, 4K@30 fps (3840×2160) means 3840×2160 pixels/frame at 30 frames per second and needs up to 4 times more bitrate than 1080p@30 fps (1920×1080 pixels/frame at 30 frames per second). An example is 1080p@30 fps needs 4 Mbps while 4K30 fps needs up to 16 Mbps.

When streaming the video of a particular resolution, the streaming service also needs to prepare lower resolutions in case of fluctuating Internet bandwidth. For example, while streaming 4K@30 fps resolution, the video streaming services also needs to prepare to stream 1080p@30 fps, or 720p@30 fps or even 360p@30 fps. Downscaling is required to downscale the original 4K30 fps video or image to smaller resolution video. In case of Internet bandwidth issues, a downscaled and encoded video is sent over the Internet instead of the encoded version of the original video resolution. The smaller the Internet available bandwidth, the smaller the resolution video is needed to accommodate the smaller available bandwidth.

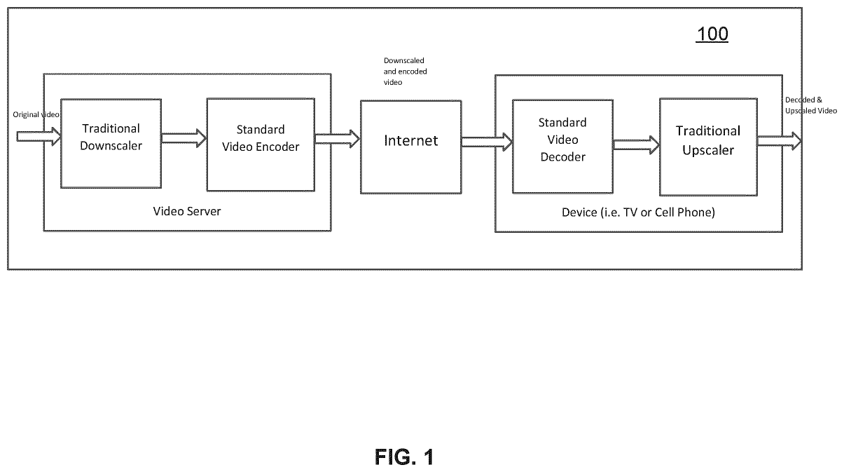

FIG. 1 illustrates, in an example embodiment, an architecture 100 of a platform video scaling system within a communication network. A video server consists of downscaler and video encoder, and device (i.e. TV or cell phone) consists of video decoder or upscaler. If there is no bandwidth issue, the downscaler is bypassed and original video is encoded before Internet video streaming. At the device end (i.e. TV or cell phone), video is decoded and the upscaler is bypassed. In case of Internet bandwidth issues, the original video is downscaled and then encoded before streaming to the Internet. The bitrate of the encoded video is much reduced to the downscaling process before encoding. At the device end, video is decoded and upscaled to the original resolution or display resolution before further processing (i.e. displaying or rendering devices such as on a TV or cellphone).

While bandwidth is reduced during the downscaling and encoding process, picture or video quality is also compromised as any downscaling typically introduces information loss to some extent.

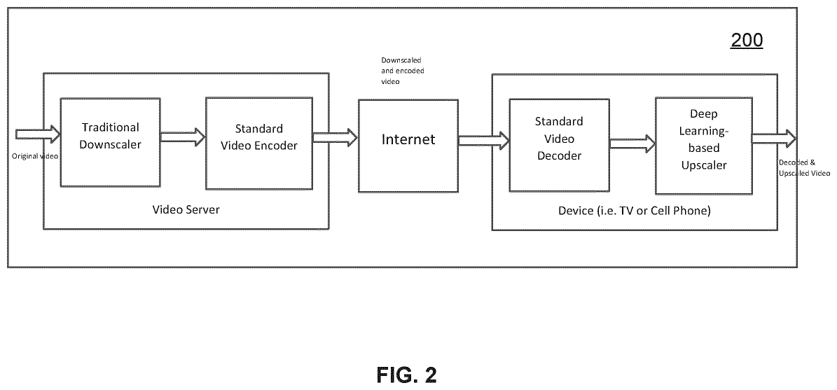

FIG. 2 illustrates, in an example embodiment, a system architecture incorporating a deep learning-based upscaling at a rendering device side.

A good quality video or image upscaler may be used at the device side to recover some of the video loss due to the downscaling process at the video server side. A deep learning-based upscaling solution may be used to improve the upscaling video quality. Deep learning-based upscaling is shown in FIG. 2. Compared to the example embodiment of FIG. 1, a traditional upscaler such as bicubic upscaling in the rendering device side may be replaced with a deep-learning-based upscaling, while the video server side may remain as depicted in FIG. 1.

While deep learning-based upscaling offers very good video quality, it is often very expensive to implement the deep learning based upscaler in the hardware (i.e. CPU, GPU or hardware accelerators). Furthermore, when upscaling from lower resolution to very high resolution, for example 1080p to 8K or 720p or lower resolution to 4K, even deep learning-based upscaling can be challenging to improve video quality.

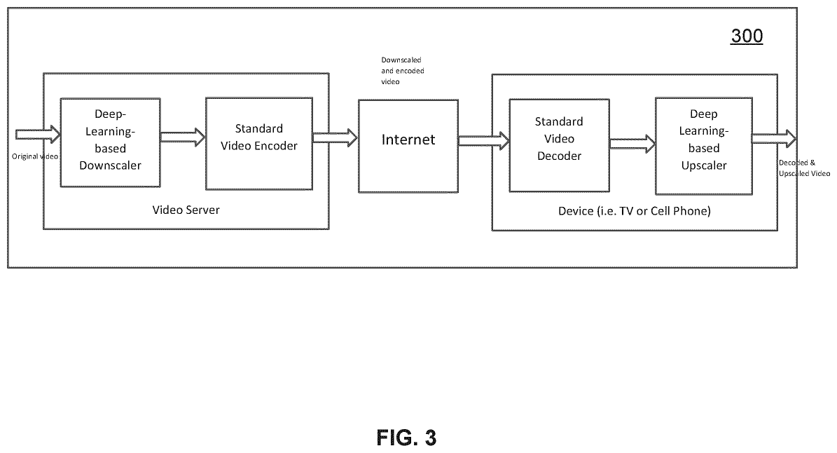

FIG. 3 illustrates, in an example embodiment, an architecture 300 of a deep learning based downscaling system. Compared to FIG. 2, deep-learning based downscaler is used instead of traditional downscaler such as bi-cubic downscaling. There are 2 prior arts in this area: 1) the deep learning based downscaling and deep learning based upscaling networks are jointly optimized; 2) the deep learning based downscaling network and deep learning based upscaling network are independently developed, and the outputs of the deep-learning downscaling network are used to train the deep-learning based upscaling network. In both cases, the introduction of the deep learning based downscaler in the video server side improves the quality of the upscaled video on the device side.

While deep learning-based scaling offers very good video quality, it is often very expensive in implementing the deep learning in the hardware (i.e. CPU, GPU or hardware accelerators). In particular, the device side is limited in supporting complex deep learning networks due to power and cost constraints.

The disclosure herein introduces a new method of device AI-resource aware jointly optimized networks for both deep-learning-based downscaling and upscaling. AI and deep learning are used interchangeably as referred to herein.

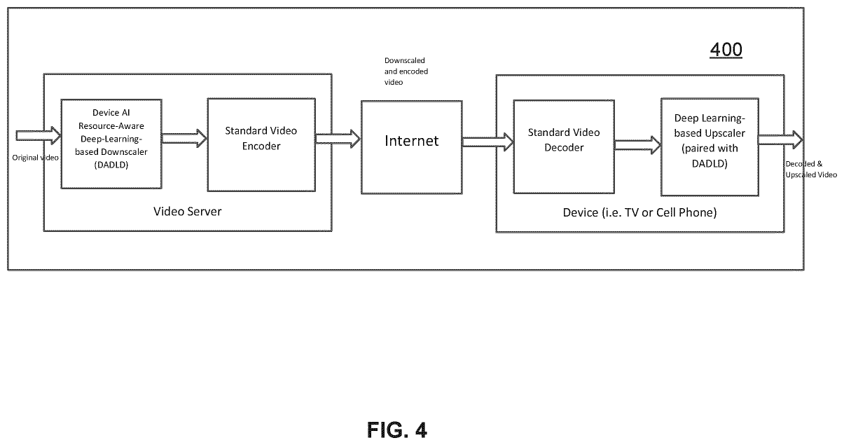

FIG. 4 illustrates, in another example embodiment, an architecture 400 of a deep learning based platform video scaling and processing system. In FIG. 4, the original video is downscaled by Device AI Resource-Aware Deep-Learning-based Downscaler (DADLD). This AI-based downscaler is designed to minimize the AI resource required in the upscaler in the device side. The downscaled video is encoded by a standard video encoder before the encoded video is sent to the Internet. In the device side, the encoded video is decoded by standard video decoder before it's upscaled by Deep Learning-based Upscaler that is paired with DADLD. The upscaled video is further processed (i.e. displayed on TV or cell phone).

Device AI-resource (or deep learning resources) can be specified in MACs/s (Multiplier and Accumulations/second). An example on how MACs/s is calculated for one 3×3 convolution layer of a deep learning network: 480×270 pixels with 3×3 convolution kernels, input channel is 128 and output feature is 128. The total MACs required per frame is=480×270×3×3×128×128=19,110,297,600 MACs per frame or 573,308,928,000 MACs/s, or ˜0.573 Tera MACs/s. If a device only has 2 Tera MACs/s of AI hardware resources, then it can only run 3 layers of similar computational complexity. Deep learning network typically has many layers. AI-resources are typically very expensive and power hungry in devices, and hence devices cannot run many deep learning network layers.

In this novel proposed technique, a minimum AI resource (i.e. GMACs/s) is assumed on the device side, and example can be 1 or 2 Tera MACs/s. On the video server side typically more AI resources can be used and it also has more power budget.

This new technique of deep learning networks is developed with the following constraints and goals: 1) device AI-resource aware with the goal of minimizing the device side AI resources; and 2) jointly optimized for both deep learning-based downscaling on the video server side and deep learning-based upscaling on the device side, with the goal of achieving video quality as close to original video.

Subjective video quality matrix and objective quality matrix (such as PSNR or SSIM) are typically used to evaluate the end-to-end video quality.

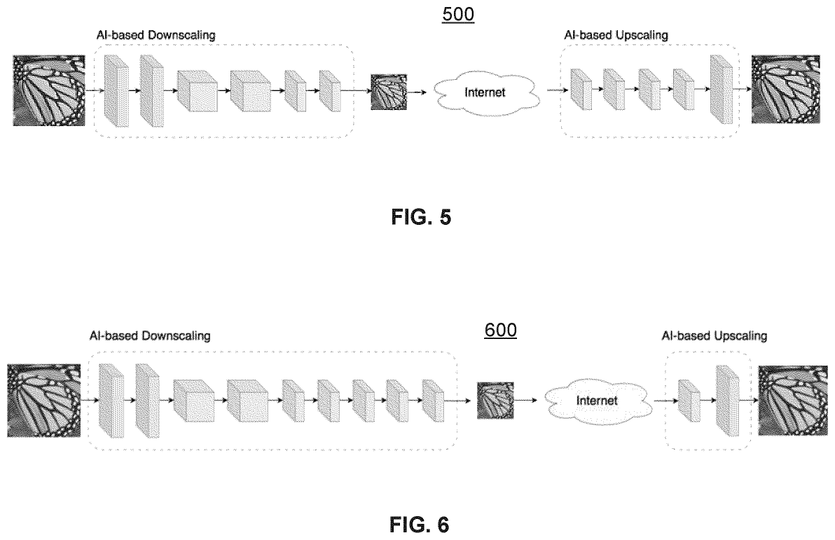

FIG. 5 illustrates, in one example embodiment, an architecture 500 of a deep learning based neural network video scaling and processing system. An example of another new network is shown in FIG. 5. In FIG. 5, device side has 5 layers for AI-based upscaling, and video server side has 6 layers for AI-based downscaling. Each cube depicted in FIG. 5 represents a layer in the deep learning network. For example, the first layer is 1920×1080 in width and height, and 32 output channels, and 3 input channels from the original image. The 2nd layer is 1920×1080 in width and height, with 32 input channels and 32 output channels. The 3rd layer is 480×270 in width and height, with 32 input channels and 128 output channels. The 4th layer is 480×270 in width and height, with 128 input channels and 128 output channels. The computational calculation of the 4th layer as described previously is about 0.573 TMACs/s.

In this case, about 30% of the overall AI computational resources are on the AI-upscaling side in the devices and 70% of the overall AI computational resources are on the AI-downscaling side in the video server. The video encoder and video decoder are omitted in FIGS. 5 and 6 for simplicity. In real practice video encoder and decoder are typically required as shown in FIGS. 1- 4.

FIG. 6 illustrates, another example embodiment, an architecture 600 of a deep learning based neural network video scaling and processing system, in a second example of another new network. In FIG. 6, rendering device side has 2 layers for AI-based upscaling, and video server side has 9 layers for AI-based downscaling. More than 90% of the overall AI computational resources are on the AI-downscaling side in the video server and only 10% of the overall AI computational resources are on the AI-upscaling side in the rendering devices. This new network minimizes the AI-resource resource requirement on the rendering device side while maximizing or maintaining the overall end-to-end video quality. More AI resources are required on the video server side which is achievable as (i) video server side typically has more AI resources and more power budget; and (ii) A downscaled and encoded video stream can be prepared offline in some cases.

Based on the foregoing examples of FIGS. 1-4 of the device AI-resource aware network, any combination of the AI-based upscaling and AI-based downscaling are possible, as long as the jointly optimized network take into the consideration of the AI source constraints in the device side with the goal of minimizing the AI source requirement.

### Methodology

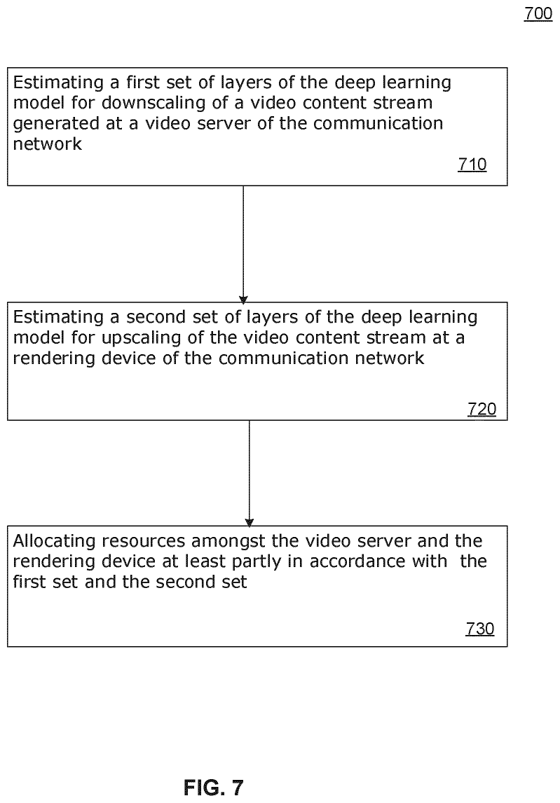

FIG. 7 illustrates, in an example embodiment, method 700 of operation for allocating video scaling resources amongst devices coupled in a communication network. In describing the example of FIG. 7, reference is made to the examples of FIG. 1 through FIG. 6 for purposes of illustrating suitable components or elements for performing a step or sub-step being described. In particular, examples of method steps described herein relate to allocating processing resources across a deep learning based video scaling and communication network.

In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is also contemplated that in alternative embodiments, the techniques herein, or portions thereof, may be distributed between several processors working in conjunction.

In FIG. 7, an example of allocating video scaling resources amongst computing and communication devices embodying at least some aspects of the foregoing example embodiments of the disclosure herein.

At step 710, estimating a first set of layers of the deep learning model for downscaling of a video content stream generated at a video server of the communication network.

In one aspect, the deep learning model may be a trained deep learning model, and in a further variation, a convolution deep learning model.

The video content, in one embodiment, may be generated at the server device, in accordance with the downscaling and the allocating for transmission to the rendering device.

At step 720, estimating a second set of layers of the deep learning model for upscaling of the video content stream at a rendering device of the communication network.

At step 730, allocating resources amongst the video server and the rendering device at least partly in accordance with the first set and the second set.

In some variations, one layer or more layers of the first set of layers for downscaling the video content at the video server, and also of the second set of layers for upscaling the video content at the rendering device may respectively be associated with a number of input channels and a number of output channels of the deep learning model.

In a further aspect, the allocating of computational processing resources for the downscaling and the upscaling may be based on the AI resources required for all the layers in an AI network. The AI resource of each layer depends on the convolution kernel size, the resolution of the image of the layer, number of input channels and the number of output channels of the layer

In response to the allocating, the method may further comprise upscaling the video content at the rendering device based on the allocating for display thereon. In embodiments, the rendering device may comprise any one or more of a television display device, a laptop computer, and a mobile phone, or similar video or image rendering devices.

In this manner, the allocating of video scaling and processing resources minimizes resources allocated for upscaling at the rendering device and optimizes the video quality of the video displayed at the rendering device.

In some embodiments, it is contemplated that the resource allocation techniques disclosed herein may be implemented in one or more of a field-programmable gate array (FPGA) device, a graphics processing unit (GPU) device, a central processing unit (CPU) device, and an application-specific integrated circuit (ASIC).

It is contemplated that embodiments described herein be extended and applicable to individual elements and concepts described herein, independently of other concepts, ideas or system, as well as for embodiments to include combinations of elements in conjunction with combinations of steps recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, any absence of describing combinations does not preclude the inventors from claiming rights to such combinations.

What is claimed is:

1. A method of allocating video scaling resources based on a deep learning model across a communication network, the method comprising:
estimating a first set of layers of the deep learning model for downscaling of a video content stream generated at a video server of the communication network;
estimating a second set of layers of the deep learning model for upscaling of the video content stream at a rendering device of the communication network; and
allocating resources amongst the video server and the rendering device at least partly in accordance with the first set and the second set.

2. The method of claim 1 wherein the allocating minimizes resources allocated for upscaling at the rendering device and optimizes the video quality of the video displayed at the rendering device.

3. The method of claim 1 wherein the deep learning model comprises a trained deep learning model.

4. The method of claim 3 wherein the trained deep learning model comprises a trained convolution model.

5. The method of claim 1 further comprising generating, at the server device, the video content in accordance with the downscaling and the allocating for transmission to the rendering device.

6. The method of claim 5 further comprising upscaling the video content at the rendering device based on the allocating for display thereon.

7. The method of claim 1 wherein at least one layer of first set and the second set respectively comprise a number of input channels and a number of output channels.

8. The method of claim 7 wherein the allocating is further based on at least one of: a convolution kernel size, a resolution of an image represented by the at least one layer, the number of input channels and the number of output channels of the at least one layer.

9. The method of claim 1 wherein the rendering device comprises at least one of a television display device, a laptop computer, and a mobile phone.

10. The method of claim 1 wherein the video scaling resources comprises a set of deep learning-based video processing computational resources.

11. A non-transient memory storing instructions executable in one or more processors to allocate video scaling resources by:
estimating a first set of layers of a deep learning model for downscaling of a video content stream generated at a video server of the communication network;
estimating a second set of layers of the deep learning model for upscaling of the video content stream at a rendering device of the communication network; and
allocating resources amongst the video server and the rendering device at least partly in accordance with the first set and the second set.

12. The non-transient memory of claim 11 wherein the allocating minimizes resources allocated for upscaling at the rendering device and optimizes the video quality of the video displayed at the rendering device.

13. The non-transient memory of claim 11 wherein the deep learning model comprises a trained deep learning model.

14. The non-transient memory of claim 13 wherein the trained deep learning model comprises a trained convolution model.

15. The non-transient memory of claim 11 further comprising generating, at the server device, the video content in accordance with the downscaling and the allocating for transmission to the rendering device.

16. The non-transient memory of claim 15 further comprising upscaling the video content at the rendering device based on the allocating for display thereon.

17. The non-transient memory of claim 11 wherein at least one layer of first set and the second set respectively comprise a number of input channels and a number of output channels.

18. The non-transient memory of claim 17 wherein the allocating is further based on the at least one of: a convolution kernel size, a resolution of an image represented by the at least one layer, the number of input channels and the number of output channels of the at least one layer.

19. The non-transient memory of claim 11 wherein the rendering device comprises at least one of a television display device, a laptop computer, and a mobile phone.

20. The non-transient memory of claim 11 wherein the video scaling resources comprises a set of deep learning-based video processing computational resources.
